(19) United States
(12) Patent Application Publication
(10) Pub. No.: US 2015/0161710 A1
(43) Pub. Date: Jun. 11, 2015

(54) METHODS AND APPARATUS FOR ASSOCIATING ARCHETYPE MOTIVATORS WITH A PURCHASER DECISION

(71) Applicant: Lela, Inc, New York, NY (US)

(72) Inventor: Dmitry Korobkov, London (GB)

(21) Appl. No.: 14/624,644

(22) Filed: Feb. 18, 2015

Related U.S. Application Data
(63) Continuation-in-part of application No. 13/607,757, filed on Sep. 9, 2012.
Application No. 13/607,757 is a continuation-in-part of application No. 14/548,258, filed on Nov. 19, 2014.
(60) Provisional application No. 61/943,465, filed on Feb. 23, 2014.
(60) Provisional application No. 61/905,864, filed on Nov. 19, 2013.
(60) Provisional application No. 61/905,866, filed on Nov. 19, 2013.

(51) Int. Cl. G06Q 30/06

(52) U.S. Cl. CPC G06Q 30/0631

(57) ABSTRACT

The present invention provides methods and apparatus for associating a dominant archetype and a non-dominant archetype with a Purchaser and associating a Product with the Purchaser based upon the dominant archetype and non-dominant archetype. The Purchaser may make a decision related to a purchase of the Product or Service. An automated service will provide a description of a Product that will satisfy a Purchaser in the event that the Purchaser acquires the Product or Service. The assistance is based upon archetypal motivators associated with one or both of the Purchaser and the Product or Service.

### CROSS REFERENCE TO RELATED APPLICATIONS

The present application claims priority to the U.S. Provisional Patent Application Ser. No. 61/943,465 filed Feb. 23, 2014 and entitled “METHODS AND APPARATUS FOR ASSOCIATING ARCHETYPAL MOTIVATORS WITH ONLINE DECISIONS”. The present application also claims priority to U.S. patent application Ser. No. 13/607,757 filed, Sep. 9, 2012 and entitled, “METHODS FOR AND APPARATUS FOR ASSOCIATING EMOTIONAL MOTIVATORS WITH PRODUCTS”, as a Continuation in Part patent application. The present application also claims priority to U.S. patent application Ser. No. 14/548,258 filed Nov. 19, 2014 and entitled “METHODS AND APPARATUS FOR PROVIDING AUTOMATED EMOTIONAL MOTIVATOR BASED SERVICE” as a Continuation in Part application. U.S. patent application Ser. No. 14/548,258 in turn claims priority to U.S. Provisional Application Ser. No. 61/905,864 entitled “METHODS AND APPARATUS FOR AUTOMATED CROSS SALE BASED UPON EMOTIONAL MOTIVATORS” filed Nov. 19, 2013. U.S. patent application Ser. No. 14/548,258 in turn claims priority to U.S. Provisional Application Ser. No. 61/905,866 entitled “METHODS AND APPARATUS FOR AUTOMATED MESSAGING BASED UPON EMOTIONAL MOTIVATORS” filed Nov. 19, 2013. The contents of each of which are relied upon and hereby incorporated by reference.

### FIELD OF THE INVENTION

The present invention relates to methods and apparatus for assessing archetypal motivators and recommending a product or service based upon a match of the user's archetypal motivators to one or more characteristics of a product or service. More specifically, the present invention includes computerized apparatus logically connected and programmed to assess a user's archetypal motivators and match a quality of one or both of a product or service with the user's archetypal motivators.

### BACKGROUND OF THE INVENTION

In today's world, a Purchaser may often find it beneficial to receive assistance in making a decision as to which Product or Service the Purchaser should select. A sheer number of choices presented by a number of products available and a number of vendors and venues, both online and brick and mortar, may be overwhelming. Decision making may be further complicated by time constraints faced by a user. Time pressures to make a decision on which Product or Service to purchase make it difficult for a Purchaser to conduct detailed research into various Products available. As a result, Purchaser is often forced into a decision to Purchase with little understanding about whether the Purchase will prove satisfactory to the Purchaser.

Advertisement may be helpful, but does not fully remedy the problem since advertising is almost as much art as it is science. Advertising agencies attempt to ascertain what will appeal to the masses and then position products in a light which it guesses will sell those products. Demographic data is collected and reviewed to study which products appeal to various demographic groups, and advertisement media may be tailored to reach those demographic groups.

Online sales have allowed advertising to evolve and online sellers may now suggest additional products to a user for the user to purchase based upon a purchasing history of the user. The advertising agency and seller may have other data sources to quantify user demand which the advertiser and seller may analyze and study to better position themselves with respect to segments of society that may purchase their goods.

However, there has not existed a tool which allows a user who is a potential purchaser to process data on various available products and equate those products on a personal basis in order to ascertain which Products will prove to be satisfactory to the Purchaser.

### SUMMARY OF THE INVENTION

Accordingly, the present invention provides a Purchaser with methods and apparatus for providing guidance relating to a purchase, a life event or other decision which may involve archetypal motivators in order to have the Purchaser be more satisfied with a Purchasing decision. The essence of the present invention includes providing an automated system indicating an appropriateness of a purchase according to which Products or Services are most likely to satisfy one or more archetypal motivations specifically related with a user. Options which satisfy archetypal motivators of a user, such as a Purchaser, are based upon an interactive assessment of the user's emotional state. The interactive assessment may be provided via a distributed communications network and thereby become widely available for use by the Purchaser.

In another related aspect, the present invention receives input data that is descriptive of one or more Products or Services, and associates emotional qualifiers to Products and Services. Emotional qualifiers represent which archetypal motivators may be met by a particular Product or Service. In some preferred embodiments, emotional qualifiers are associated with “hard” dictionary classifications and “soft” dictionary classifications.

A related aspect of the present invention provides methods and apparatus for generating and presenting an interface which facilitates a user in making choices that will make that particular user happier with a choice, such as a purchasing decision. The interface may be presented over a distributed network, such as the Internet.

Essentially, the present invention first determines what matters most to a user and then correlates a decision, such as which product to purchase, with that which motivates the user. In some preferred embodiments, steps directed to determining what matters most to a user are determined via “playful” activities. Other embodiments may include traditional question and answer input.

One general aspect includes automated apparatus for providing advice to a purchaser to make the purchaser more satisfied with a purchasing decision based upon archetypes, the apparatus including: a processor in logical communication with a digital storage device, the digital storage device storing executable software code, executable upon command to cause the apparatus to transmit via a communications network, a first interactive user interface to a network access device, said first interactive user interface including a device for the purchaser to select one of multiple images indicative of archetype motivators. The execution may also cause the apparatus to receive a first purchaser input indicating an image selected from the multiple images indicative of archetype motivators. The execution may also cause the apparatus to transmit via the communications network, a second interactive user interface to the network access device, said second interactive user interface including multiple questions indicative of archetype motivators. The execution may also cause the apparatus to receive via the communications network, a second purchaser input indicating respective answers provided by the purchaser to each of the multiple questions indicative of archetype motivators. The execution may also cause the apparatus to generate a user archetype profile for the purchaser based upon the selected image and the respective answers provided by the purchaser to each of the multiple questions indicative of archetype motivators, where the archetype profile includes at least one dominant archetype and at least one non-dominant archetype. The execution may also cause the apparatus to associate dominant and non-dominant archetypes with a product based upon attributes of the product. The execution may also cause the apparatus to receive from the purchaser, via the communications network, a selection of a type of product the purchaser is interested in purchasing. The execution may also cause the apparatus to match the at least one dominant archetype and at least one non-dominant archetype associated with the purchaser with the at least one dominant archetype and at least one non-dominant archetype associated with the product. The execution may also cause the apparatus to transmit to the purchaser a third interactive user interface including a description of the product.

Implementations may include one or more of the following features. The apparatus where the processor is additionally operative to transmit to the purchaser a discount artifact entitling the purchaser to a discounted price for the product described in the third interactive user interface. The apparatus where the processor is additionally operative to transmit to the purchaser a link to a virtual point of purchase for the product described in the third interactive user interface. The apparatus where the processor is additionally operative to determine a physical point of purchase geographically local to the purchaser. The execution may also cause the apparatus to determine that the physical point of purchase stocks the product which is described in the third interactive user interface. The execution may also cause the apparatus to transmit a map including the physical point of purchase geographically local to the purchaser.

The apparatus may additionally include aspects where the processor is additionally operative to transmit a purchaser interactive display including a description of archetypal motivators associated with the purchaser and including the at least one dominant archetype and at least one non-dominant archetype associated with the purchaser. The apparatus may additionally include aspects where the processor is additionally operative to display a history of purchase transactions completed by the purchaser. The apparatus may additionally include aspects where the processor is additionally operative to display a history of inputs including indications of archetypal motivators associated with the purchaser. The apparatus may additionally include aspects where the processor is additionally operative to transmit an indication of how well a software engine designed to quantify archetypal motivators is aware of purchaser preferences based upon archetypal motivators. The apparatus may additionally include aspects where the processor is additionally operative to transmit an indication of which archetypal motivators are associated with the purchaser. The apparatus may additionally include aspects where the processor is additionally operative to transmit to the purchaser an indication of archetypal motivators associated with the product chosen by the purchaser.

One general aspect includes examples where the method additionally includes the step of transmitting a discount artifact entitling the purchaser to a discounted price for the one or more products determined to be satisfactory to the purchaser. The method includes examples where the method additionally includes the step of transmitting a link to a virtual point of purchase for the one or more of the products determined to be satisfactory to the purchaser based upon archetype motivators associated with the purchaser. The method includes examples where the method additionally includes the step of receiving a link to a geographically local point of purchase for one or more of the products determined to be satisfactory to the purchaser based upon archetype motivators associated with the purchaser. The method includes examples where the method additionally includes the step of transmitting a purchaser interactive display including a description of archetype motivators associated with the purchaser. The method where the method additionally includes the step of transmitting a history of purchase transactions completed by the purchaser. The method includes examples where the method additionally includes the step of transmitting a history of inputs including indications of archetype motivators associated with the purchaser. The method includes examples where the method additionally includes the step of transmitting an indication of how well a software engine designed to quantify archetype motivators is aware of purchaser preferences based upon archetype motivators. The method includes examples where the method additionally includes the step of transmitting to the purchaser an interface including an indication of the dominant archetype and the non-dominant archetype associated with the purchaser. The method includes examples where the method additionally includes the step of transmitting to the purchaser an interface including a description of the dominant archetype and the non-dominant archetype associated with the product determined to be satisfactory to the purchaser based upon archetype motivators associated with the purchaser.

One general aspect includes a computerized method for providing advice related to a purchase decision, the method including transmitting a purchaser interface for making selections which indicate archetype motivators of a purchaser. The computerized method also includes receiving one or more indications of archetype motivators including a purchaser dominant archetype and a purchaser non-dominant archetype associated with the purchaser. The computerized method also includes associating a product dominant archetype and a product non-dominant archetype with a product. The computerized method also includes transmitting a purchaser interface for receiving a selection of a type of product the purchaser is interested in. The computerized method also includes determining that the product will be satisfactory to the purchaser based upon the dominant archetype and a non-dominant archetype associated with the purchaser. The computerized method also includes transmitting a display descriptive of the product determined to be satisfactory to the purchaser based upon archetype motivators associated with the purchaser.

Implementations may include one or more of the following features. The method where the method additionally includes the step of transmitting a discount artifact entitling the purchaser to a discounted price for the one or more products determined to be satisfactory to the purchaser. The method where the method additionally includes the step of transmitting a link to a virtual point of purchase for the one or more of the products determined to be satisfactory to the purchaser based upon archetype motivators associated with the purchaser. The method where the method additionally includes the step of receiving a link to a geographically local point of purchase for one or more of the products determined to be satisfactory to the purchaser based upon archetype motivators associated with the purchaser. The method where the method additionally includes the step of transmitting a purchaser interactive display including a description of archetype motivators associated with the purchaser. The method where the method additionally includes the step of transmitting a history of purchase transactions completed by the purchaser. The method where the method additionally includes the step of transmitting a history of inputs including indications of archetype motivators associated with the purchaser. The method where the method additionally includes the step of transmitting an indication of how well a software engine designed to quantify archetype motivators is aware of purchaser preferences based upon archetype motivators. The method where the method additionally includes the step of transmitting to the purchaser an interface including an indication of the dominant archetype and the non-dominant archetype associated with the purchaser. The method where the method additionally includes the step of transmitting to the purchaser an interface including a description of the dominant archetype and the non-dominant archetype associated with the product determined to be satisfactory to the purchaser based upon archetype motivators associated with the purchaser.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments of the present invention.

FIG. 1 illustrates a block diagram of a prior art method of steps a Purchaser may take in making a purchase.

FIG. 2 illustrates a block diagram of functional modules that may be used to implement embodiments of the present invention.

FIG. 3 illustrates a block diagram of a purchase process that may be used to implement embodiments of the present invention.

FIG. 4 illustrates a block diagram of decision functions that may be included in some implementations of the present invention directed to a purchase decision.

FIG. 5 illustrates a block diagram of decision functions that may be included in some implementations of the present invention directed to a non-purchase decision

FIG. 6 illustrates a block diagram of functionalities that may be used to implement some aspects of the present invention directed to associating emotional attributes with Products.

FIG. 7A-7C illustrate block diagrams of exemplary user interfaces including functionalities that may be included in a user interface used to implement some embodiments of the present invention.

FIG. 8 illustrates apparatus that may be used to implement some embodiments of the present invention.

FIGS. 9A-9B include flow diagrams of method steps that may be experienced by a Purchaser in some implementations of the present invention.

FIG. 10-16 illustrate block diagrams representing aspects of the present invention.

### DETAILED DESCRIPTION OF PREFERRED EMBODIMENTS

The present invention provides automated apparatus with processor and executable software, wherein the software is executable upon demand to assess archetypal motivators related to making a purchase. For the purposes of this discussion, a “Purchaser” or multiple “Purchasers” include one or more individuals, or a succinctly defined organization. The present invention collects or otherwise receives subjective and objective data and associates the subjective and objective data with archetypal motivators. The collected data is digitally stored as a motivator profile which may be applied and built upon in order to assist with subsequent purchasing decisions.

Executable software is operative in conjunction with a processor to execute methodologies that match archetypal motivators to purchasing decisions. Archetypal motivators may be associated with one or more of: an individual actually making a purchase; a person who will receive a purchased good or service; and with a good or service which may be available for purchasing.

### GLOSSARY

As used herein the following terms will have the following associated meaning:
“Buying Context” as used herein means circumstantial data related to a

Purchase.
“Cross Channel” as used herein means related to a first Purchase in a first subject area with a second purchase or other decision in a second subject area.
“Emotional Reasons” as used herein Emotional Reasons means subjective archetypal motivators that form a basis for satisfaction following completion of a decision, such as, for example, a decision to make a Purchase.
“Engine” as used herein means an apparatus including a processor that executes a software process to receive one or more inputs, process the inputs, and generate an output based upon the inputs.
“Local” as used herein means in a geographic proximity reasonable to travel in order to complete a Purchase based upon objective and subjective aspects of the Purchase.
“Motivator” as used herein shall mean a factor which influences a sense of success in making a decision.
“Product” for the sake of simplicity in this discussion, as used herein a Product shall mean one or more of: a tangible item, machine or device; an intangible conveyance such as knowledge, know how or data stream; and a Service performed (as defined below).
“Purchaser” as used herein shall mean a person that makes or contemplates making a purchase.
“Service” as used herein shall mean an action performed at the request of a Purchaser.

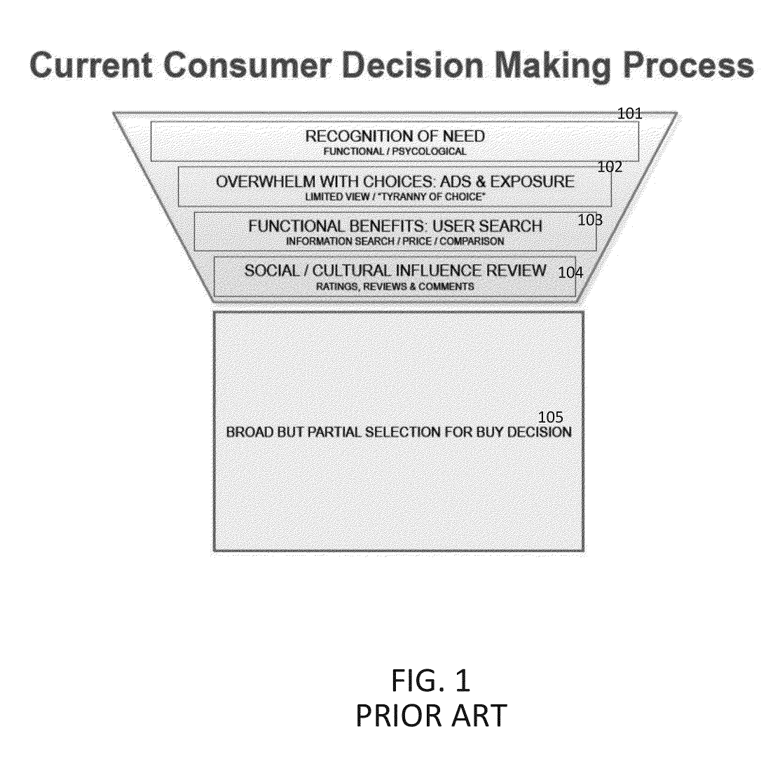

Referring now to FIG. 1, a block diagram illustrates a prior art method for a Purchaser to make a decision to purchase a product or service. At 101, the Purchaser recognizes a need for one or both of: a good and a service. A need may be essentially objective and functional in nature, such as a portion of a defined process, for example a replacement part of a machine, such as an automobile. A need may also be subjective or psychological, such as a need to purchase an item to celebrate an event.

At 102, a Purchaser looking for input may be overwhelmed with choices, advertisements and exposure to media promoting select purchase choices. The view of product and service choices is also limited to those choices that are actively advertised and promoted. At 103, a Purchaser may search functional benefits. The search may reveal information about a product or service, a price and a comparison to other available products. At 104, social and cultural influence may also affect a purchasing decision. The social and cultural influence may include one or more of reviews, ratings and comments descriptive of products.

At 105, the prior art method at best provides a broad amount of information but only partial in regard to a specific purchase event.

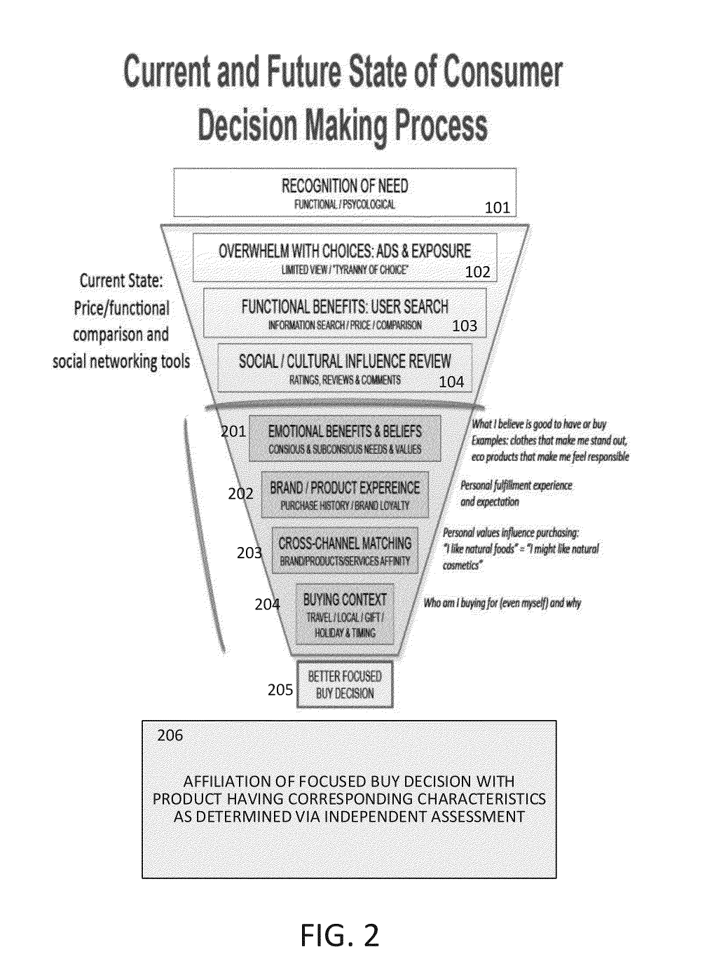

Referring now to FIG. 2, functional steps that may be executed according to the present invention are illustrated. At 201, one or both of emotional benefits and beliefs are assessed.

Emotional benefits and beliefs may be on a conscious or unconscious level and access values inherent in a Purchaser. In some preferred embodiments, discussed more fully below, a Purchaser will provide value related data as input into a computerized apparatus, wherein the data may be processed by a programmable algorithm to correlate the input data with one or more core values useful to make a purchasing decision. Emotional benefits may include, for example, whether a Purchaser believes that it is good to own or to buy Products that make the Purchaser stand out, or whether it is good to own or to buy Products that are ecologically friendly and which make the Purchaser feel responsible.

Another example of an objective need may include a need for a carriage to carry a baby during a jogging activity. A need that is essentially subjective includes a need for a stylish baby carriage that will make the Purchaser appear chic.

At 202, in addition to value based data, the computerized apparatus may include one or both of brand and product experience. A purchase history may also be used, in addition to brand loyalty, or in place of brand loyalty.

At 203, in some embodiments, cross channel matching may be implemented. Cross channel matching includes determining an emotional reason for affinity to a first one or more of: a brand, a Product; and a service. With Cross-Channel matching, one or more Emotional Reasons is stored and made available to be applied to at least a second one or more of: a brand, a Product; and a service. The application of the Emotional Reason to the second one or more of a brand, a Product; and a service, facilitates a recommended choice of purchase of the second brand, Product; or service.

At 204, a buying context may also be considered in making a recommendation of a purchase. A buying context may include, for example, whether the purchase will be: made during travel; from a local vendor (or at least a vendor with a local presence); for a gift for another person; is associated with a holiday; or has specific timing constraints. By way of non-limiting illustration, a buying decision may be for a gift that will be picked up during travel to a particular destination and during particular calendar days. In another illustrative example, a purchase may be for a person supplying archetypal motivators and be for a purchase that will be made local on a same day as purchasing research is conducted.

At 205 a Purchaser is presented with a better focused buying decision. The focus may include a clear representation of who, what, where and when a purchase will be made.

At 206, the present invention correlates a Purchasers Archetypal motivators with a Product having corresponding Motivator characteristics as determined via an independent assessment of the Product (discussed further below).

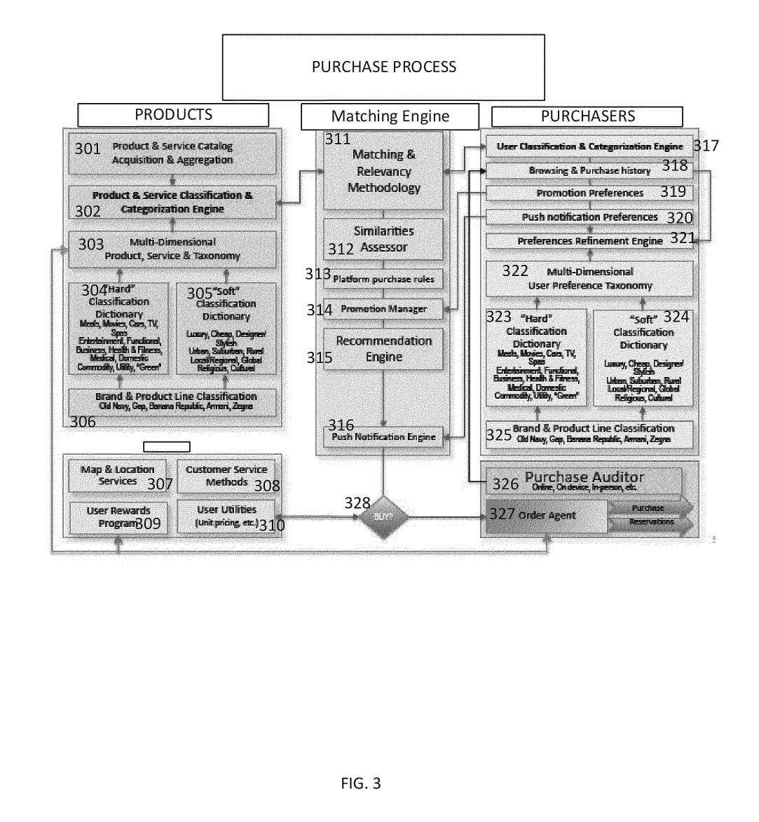

Referring now to FIG. 3, a process is presented according to some embodiments of the present invention. On a high level, the process includes method steps that may be implemented to practice novel aspects of the invention, including, for example, associating Archetypal motivators to Products and Services; associating Archetypal motivators with a Purchaser, and matching one or more Products and Services with a Purchaser. At 301, data is aggregated which is descriptive of one or more Products. The data may include, for example, catalogs, whether physical or virtual with information quantifying aspects of a Product.

At 302, the aggregated data is input into a Product and Service Classification and Categorization Engine. In essence, the engine is a computerized apparatus with programmable code. The programmable code is executable upon demand to parse, sort and link various aspects of the aggregated data according to one or both of predefined taxonomies and relationships and taxonomies and relationships “grown” as a result of data analysis. For example, it is within the scope of the present invention to associate product data with taxonomies and relationships previously encountered by a Product and Service Classification and Categorization Engine or have the engine create new taxonomies and relationships, based upon aggregated Product data received.

At 303, multi-dimensional data may therefore be generated which includes taxonomy tables relevant to a Product and which excludes taxonomy tables not relevant to a Product.

At 304, in some preferred embodiments, a Categorization and Classification Engine will allocate at least some of the aggregated data into a relatively objective “Hard” Classification Dictionary. A Hard classification may include, for example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

At 305, additionally, some preferred embodiments may include a Categorization and Classification Engine which allocates at least some of the aggregated data into a relatively subjective “Soft” Classification Dictionary. A Soft classification may include, for example, one or more of: luxury, cheap, designer, stylish, urban, suburban, rural, local, regional, global, religious, and cultural or other taxonomy or classification which is essentially relative to other taxonomies.

At 306, some exemplary embodiments may also include recognition of a brand associated with a Product. The brand may include a trademark or other designation that associates a Product with a manufacturer or service provider. It is preferable that the brands also be associated with the taxonomies and classifications included in the hard Classification Dictionary and the Soft Classification Dictionary.

At 307-310, additional considerations that may be included in a presentation to a Purchaser of a Product suitable to the Purchaser are illustrated. Additional considerations may include, for example, at 307, a map with an indication of where a Product or Service is available. In some embodiments, a location of a Product or Service may be shown relative to a location of an interested Purchaser. At 308, customer service methods, conditions, and terms may also be a considered taxonomy. At 309, a rewards program along with the conditions and terms of the program may be in included taxonomy. At 310 user utilities that may also be an included Taxonomy.

A matching engine may include automated apparatus including a processor, a digital storage device and executable software stored on the digital storage and executable upon command to match Products 311 which may include goods and services with Purchasers. At 312, a Similarities Assessor may include executable code for associating Emotional Qualifiers with products and Archetypal motivators with users and base similarities of one or both based upon the associations. A Platform Purchase rules module 313 may be used to quantify the logistics of making a purchase for a particular platform on which the resent invention is implemented. For example, an online website may of a first set of Platform Purchase rules 313 and an in store kiosk may include a second set of Platform Purchase rules 313.

In some embodiments, a Promotion Manager 314 may be included for promoting one or more of: a brand, a vendor, a product and a service. Promotion may include interactions with a user via a graphical user interface. A Recommendation Engine 315 is functional to make a Purchase recommendation to a Purchaser based upon the method steps of the present invention. A Push notification engine 316 may be utilized in some embodiments to provide push services to a user, such as a Purchaser of Product related information, such as, for example, availability of a Product, a price of a Product, a promotion of a Product, or other information.

Considering now a Purchaser and taxonomies and data that may be input indicative of the Purchaser's Archetypal motivators, items 318-327 include various aspects of data that may be included by a user categorization and classification engine (sometimes referred to herein as “CC Engine”) 317 practicing the method steps of the present invention.

As defined herein a Motivator may include for example, one or more of: a need for physical safety and emotional security; a need for acceptance (and approval), the need to belong to the group; a sense of self-worth and the need to have others validate one's worth; a need for attention (and the need to attract attention) from others; a need for acknowledgment and approval from those in authority; a need for physical affection and comfort; and a need to control money or other manifestation of material abundance.

At 318, the CC engine 318 may receive and process data indicative of one or both of a browsing history and a purchasing history of a Purchaser. A CC Engines may receive and process data indicative of one or both of: promotion preferences of a Purchaser 319; and push notification preferences of a Purchaser 320. At 321, a Preferences refinement engine may correlate various Purchaser preferences and generate preference trends for a Purchaser. The Purchaser trends may be included in a multi-dimensional Purchaser preference taxonomy or other user preference taxonomy, generated by a computerized device implementing the present invention.

At 322, a multi-dimensional user preference taxonomy may be employed which includes input from a Product hard classifications dictionary 323 and a Product soft classifications dictionary 324. The Product hard classifications dictionary 323 may include, by way of non-limiting example, one or more of: Meals, Movies, Television, Entertainment, Functional Business, Health, Fitness, Spas, Medical, Domestic, Foreign, Commodity, environmentally friendly or “Green” or other relatively bright line test for inclusion or exclusion on an objective basis.

The Product “Soft” Classification Dictionary 324 may generally include by way of non-limiting example, one or more of: luxury, cheap, designer, stylish, urban, suburban, rural, local, regional, global, religious, and cultural or other taxonomy or classification which is essentially relative to other taxonomies.

Product and brand classification may also include recognition of a brand associated with a Product. The brand may include, for example, a trademark, service mark, or other designation that associates a Product with a manufacturer or service provider. It is preferable that brands also be associated with taxonomies and classifications included in the hard Classification Dictionary and the Soft Classification Dictionary.

Classification systems may also include brand and Product classifications 325. Product and Brand classification may, for example, include associations of Emotional Qualifiers with Products and/or Brands, wherein the Products and Brands may thereby be associated with Archetypal motivators via the Emotional Qualifiers.

A Purchaser may make a decision to execute a Buy action 328 and make a purchase. An order agent 327 may be used to implement a purchase instruction associated with a Buy action 328. As discussed further below, a Buy action 328 may be communicated to a computerized system via a user interactive device. The user interactive device may be any apparatus that is functional to interface between a human and a computerized system. The user interactive device may therefore include, for example, one or more of: a keyboard, mouse other pointing device, touchscreen, auditory voice command, neural interactive device or other apparatus.

The Order Agent 327 may essentially function as an interface between a user instruction and a purchase or reservation system or module. The Order Agent 327 will provide data to a purchase or reservation system or module sufficient for the purchase or reservation module to execute the Purchase instruction.

In another aspect of the present invention, a Purchase Auditor module 326 may track or audit purchases made by a Purchaser, or group of Purchasers (trending). The Purchase Auditor function may provide analysis of purchasing activity and plot any trends that may be present within data of a Purchaser or group of Purchaser's history. Accordingly, at a first given time period, a Purchaser may be primarily motivated by a first set of Motivators which are based upon a first set of Emotional Reasons. During a second time period, a prevalence of a second set of Emotional Reasons may emerge.

For example, during a first time period, a Purchaser may be primarily motivated by an Emotional Reason of wanting to be stylish or chic. This may correlate, with a period of financial success and significant social interaction. During a second time period, a Purchaser may be primarily motivated by an Emotional Reason of seeking high quality and durability. This period may correlate with a period of financial challenge and focus on raising a family, or other caregiving.

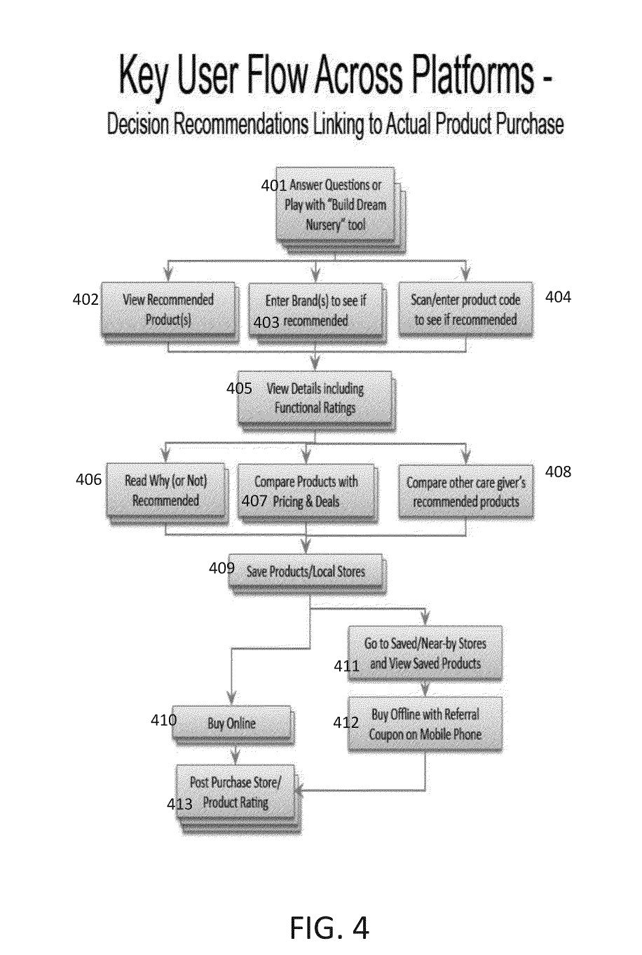

Referring now to FIG. 4, a block diagram illustrates a flow of key user functions across computerized apparatus platforms that may be implemented to facilitate a Purchaser's decision to make a Product purchase. As with other functional modules described herein, the key user functions may be implemented on a computerized device via executable software, executed upon demand. At 401, a Purchaser or other user, may provide input which may be used as input into a Motivator engine to determine primary Emotional Reasons the Purchaser will use to make a Purchase. The input may include, for example, answering questions presented to them about seemingly unrelated choices, or “playing” with an interactive virtual reality scene, such as a “Build a Dream Nursery” tool.

At 402, a computerized system implementing the present invention may allow the Purchaser to view Products which are recommended, based upon input received from the Purchaser. At 403, a Purchaser may also designate a Purchaser preferred brand and the system may indicate if the Purchaser preferred Brand is included in a list of recommended Products.

At 404, a Purchaser may also scan a UPC code or another product identifying code and input the code into the system. The code may be accessed, for example while the Purchaser is shopping in a brick and mortar type store, or at some other time when the Purchaser is observing a Product, such as, for example, when examining a product purchased by a friend. The system may also provide a response indicating whether the scanned item is a recommended item.

At 405, a Purchaser may view details including functional ratings of Products being considered by the Purchaser. The details and ratings may be compiled from multiple sources, including, for example, manufacturer specifications, independent reviews, online blogs, government agencies, ratings entities, or other source.

At 406-408, a Purchaser may receive feedback related to Products of interest to the Purchaser. At 406, feedback may include, for example, why a Product is recommended, or not recommended. At 407 relative prices and purchasing deals for recommended Products may be compared. At 408, Products recommended by other Product users, such as one or more other care givers may also be provided to the Purchaser.

At 409, in some embodiments, a Purchaser may communicate with a store, such as a brick and mortar establishment via a communications network, such as the Internet. Communication with a local store may allow the Purchaser to check inventory of the store for a preferred Product. In addition, in some embodiments, a Purchaser may reserve or save a desired Product at the local store so that the Purchaser may go to the store and review the Product. In addition, a link may be transmitted to the Purchaser allowing the Purchaser to access a map including the location of a local store selling a Product selected for the Purchase based upon a Dominant archetype and a non-dominant archetype associated with the Purchaser and a congruent archetype and a non-dominant archetype associated with the Product.

At 410, a Purchaser may complete a purchase of a Product online via a virtual storefront, or a virtual exchange. At 411, a Purchaser may physically visit a store and view Products the Purchaser may potentially purchase. At 412 Purchaser may also make a Purchase in the local store. At 413, a Purchaser may provide to a Purchasing system feedback, such as a rating or other indication of the Purchaser's satisfaction with a purchased product or the suitability of a particular product for a purpose.

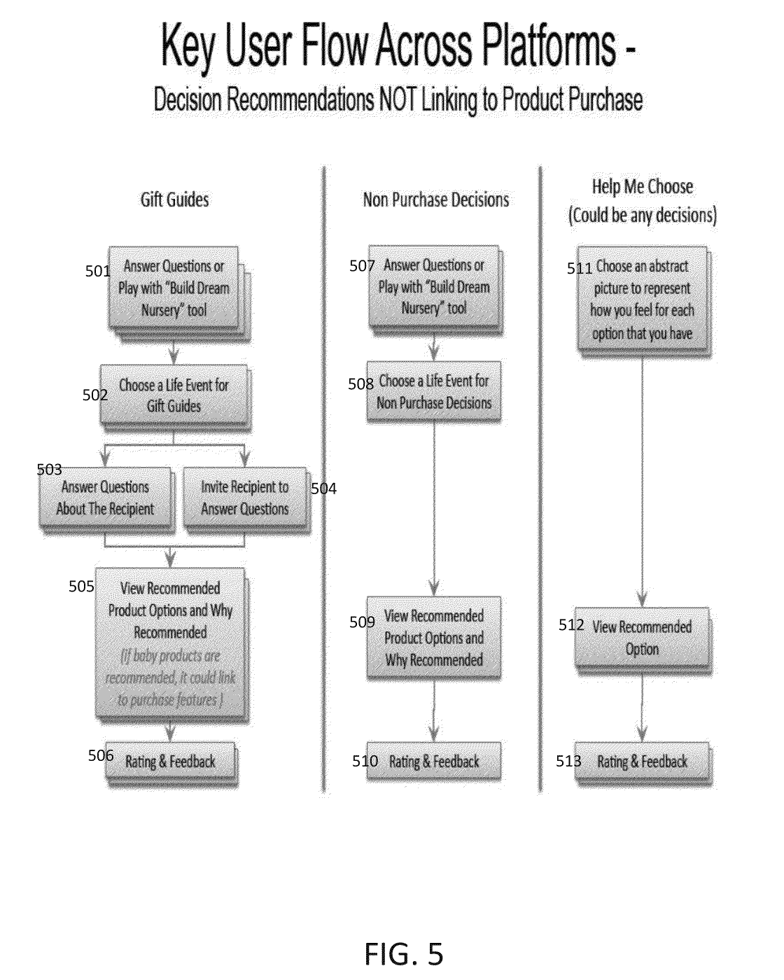

Referring now to FIG. 5, a block diagram illustrates a flow of key user functions across computerized apparatus platforms that may be implemented to facilitate purposes other than a Purchaser's decision to make a Product purchase. At 501-506 steps are illustrated which allow the present invention to be implemented in situations where a Purchaser is making a Purchase for a gift. At 501, a Purchaser may answer interview questions. In some embodiments, answers to questions are gleaned from an interactive activity. The interactive may be presented as a virtual game or a virtual tool. For example, one interactive activity may include a virtual “Build a Dream Nursery” activity. A Purchaser, or in some embodiments, a gift recipient or other relevant person, is encouraged to virtually create a nursery. The present invention, allows a computerized apparatus to track selections made in attributes of the nursery. The attributes chosen may be utilized in lieu of, or in addition to, answers to questions from the Purchaser or other user.

As part of input to an eventual Product recommendation for a given circumstance, at 502, a life event may be chosen for a gift guide. At 503, a Purchaser, or other user may provide answers about a gift recipient. The answers may be submitted to a computerized device via any known user interactive tool. At 504, in addition, in some embodiments, a gift recipient may be invited may be invited to provide answers to questions. For example, a gift recipient may be sent an electronic communication, such as one or more of: an email, a text, and a social media posting. The gift recipient may follow instructions included in the electronic invitation to a website which allows the gift recipient to identify themselves and answer the questions.

At 505, the present invention allows for one or both of the Purchaser (gift giver) and the gift recipient to view information in a human readable form that is descriptive of recommended Products. In some embodiments, the Purchaser and gift recipient are also provided with information descriptive of why one or more particular Products are recommended. At 506 one or both of the Purchaser and the gift recipient are provided with a user interactive interface for providing a rating on a Product and other feedback on one or more of: a Product; the recommendation; and the emotional motivator process for making recommendations.

In another aspect of the present invention, it is noted that an automated system which uses Emotional Reasons and Motivators to assist in decision making is not limited to decisions relating to potential purchases. Almost any decision may be assisted with an understanding and application of knowledge relating to underlying emotions and motivators.

At 507, a user may undertake one or more activities, such as answering questions or participating in a virtual activity. The virtual activity may include, for example, a game or a tool which provides queries to a user for instructions on how to create something online. At 508, in some embodiments, a life event may be associated with a non-purchase decision which will be made by a user. At 509, the user may view recommendations based upon the input received by, or about, the user. The recommendations may include, for example, one or more of: a recommended action step, or course of action; a Product selection; and a collaboration with a particular person or group of people. At 510, a user interactive interface may also be utilized for providing a rating or feedback related to the services and recommendations.

At 511, in a still broader, or higher level, implementation, a user may be asked to choose abstract picture or image which represents how a user “feels” or emotionally responds to one or more options presented to the user. At 512, the user or other party (such as a care taker, friend or employer) may view a recommended option. At 513, one or more of the user and another interested party (such as a care taker, friend or employer) may provide rating and feedback information.

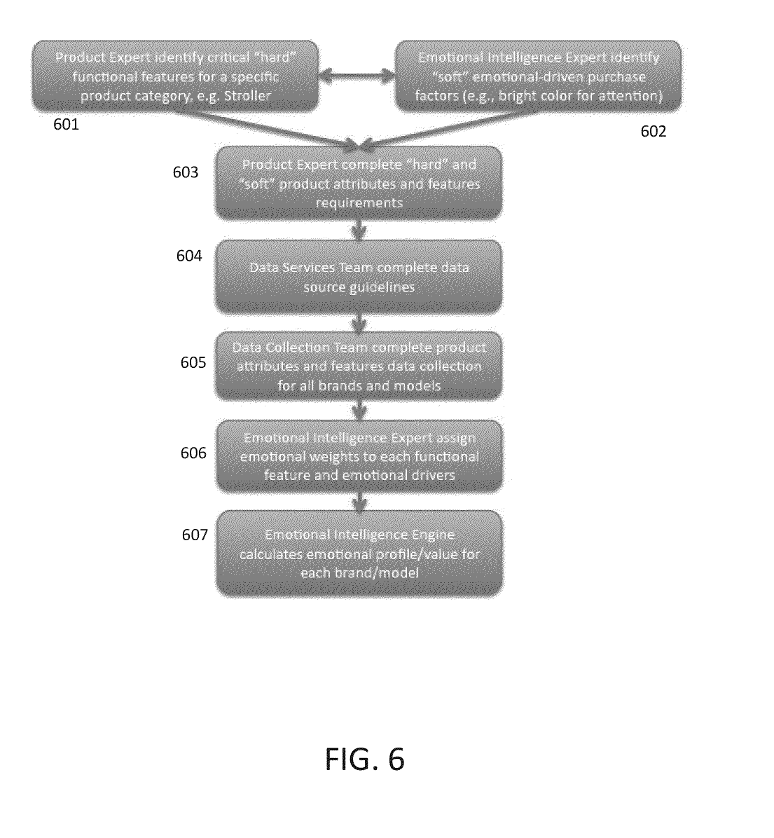

Referring now to FIG. 6, a block diagram illustrates how the present invention utilizes assessments of Products, and associates Products, with both “hard” functional attributes and “soft” emotional attributes.

At 601, the present invention receives input from one or more Product Experts which identify critical “hard” functional features for specific products category, such as, for example a baby stroller, an electronic device, a backpack, or almost any other Product. A hard functional feature may include for example, almost any empirical data, and may therefore include, for example, specifications, power ratings, physical dimensions, or other verifiable fact.

At 602, the present Emotional Intelligence Expert identifies one or more “soft’ emotional-driven purchase factors. For example, a Product with a bright color may be associated with an emotional need for attention, a Product with rugged features and durability may be associated with a need to appear masculine. The soft features may be obtained from a database of available features and how those features may translate into, and evoke human emotions.

At 603, a Product Expert may complete a combination of hard and soft product attributes and feature requirements for a Product desired by a Purchaser or other user. At 604, a data services team may provide data source guidelines for a Product. The data source guidelines may include the data fields and definitions for datum that will be compiled for particular product groups. The data source guidelines will serve as an indication of which data fields should be collected for a particular Product, or Product group.

At 605, a data collection team may be tasked with providing the data fields specified by the Product Experts. The data collection may aggregate an input data values into a database which is made available to various engines to facilitate Product selection based upon Motivators and Emotional reasoning.

At 606, in some preferred embodiments, emotional weights are assigned to at least some, if not all of the functional features and emotional drivers. One natural choice is to have one or more emotional intelligence experts assign weights to functional features, and weights to emotional drivers. A weight may include, for example, an alpha numerical value that is associated with a relative scaled value. Other ratings or weights are also within the scope of the present invention, such as, for example, a color coded value.

At 607, in some preferred embodiments, an Emotional Intelligence Engine calculates a value which is associated with an emotional profile for a Product. The value associated with an emotional profile is preferably stored in a data structure which allows the value to be retrieved upon demand. The value may include multiple dimensions. For example, the value may include a scaled indication of an appearance of fiscal status, such as, for example, the brand name Louis Vuitton™ may represent wealth, another emotional value may provide an indication of durability, another emotional value may provide an indication of subtleness or loudness. Other emotional values may be included within the scope of the invention, wherein any emotional value that may be influential in a Purchase decision or other decision at hand may be included.

### Apparatus

The teachings of the present invention may be implemented with any apparatus capable of embodying the innovative concepts described herein. Image presentation can be accomplished via any multimedia type interface. Embodiments can therefore include a PC, handheld, game controller; PDA, cellular device, HDTV or other multimedia device with user interactive controls, including, in some embodiments, voice activated interactive controls.

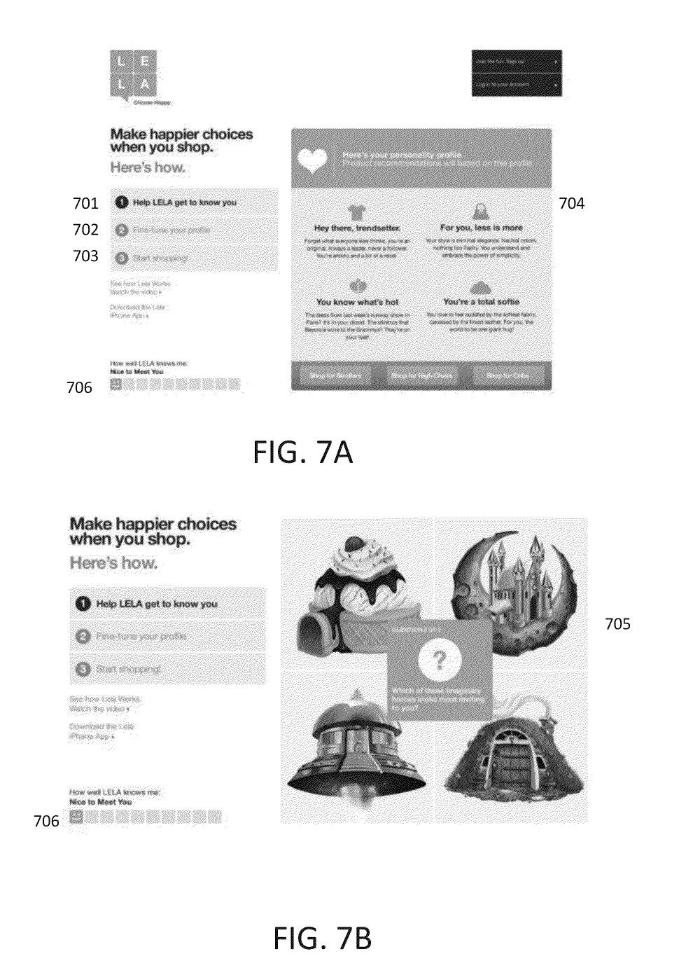

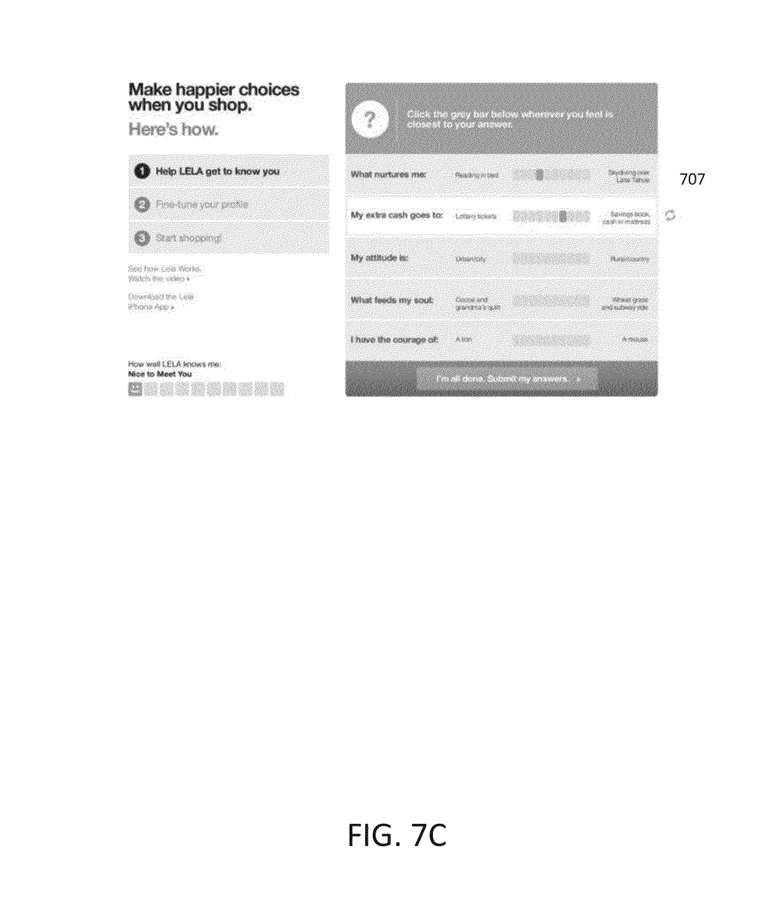

Referring now to FIG. 7A, an exemplary user interactive interface is illustrated. The interface includes multiple user interactive areas which may receive input from a user and provide one or both of human readable content or human recognizable images. Interactive areas may include, by way of non-limiting example, one or more of: a) a user interactive area on a screen that prompts a user of “Help LELA get to know you” 701; b) Fine tune your Profile 702; c) Start Shopping 703.

The Help LELA get to know you interactive area 701 is illustrative of a service such as the LELA™ service. This interactive area 701 may be selected by a user to lead the user through a series of interactive queries designed to educate a LELA software engine about a user. For example, in some preferred embodiments, images may be presented to a user wherein the user is prompted to select one of multiple images in response to one or more questions. In addition, questions may be presented in sentence format and also be used to help LELA “know” the user. In some embodiments, the LELA questions are designed to have the user provide answers that are indicative of one or more archetypal motivators that influence the user.

At 702 the user may also be provided with an area that allows the user to “fine tune” or otherwise modify the user profile, including archetypal motivators. In some embodiments, a user may use interactive user devices such as icons and prompts to request a new set of images related to a question or to request one or more new questions.

At 703, a user may also choose to begin shopping with assistance of a LELA™ program that relates one or more Products with archetypal motivators associated with the user.

At 704, another user interactive area may include an area that provides feedback indicating what Archetypal motivators are associated with the user. At 706, an indicator of how well a user is being serviced by a provider of an interactive interface may be found.

Referring now to FIG. 7B, additional user interactive areas may also include an area that provides an indicator of how well LELA™ knows the user. Essentially, how well LELA™ knows a user may be based upon, for example, one or more of: a number of questions answered by the user a number of images chosen by the user; a number of transactions executed by the user, a browsing history, or other forms of input.

At 705, a group of exemplary images is presented, wherein each image is indicative of one or more archetypal motivators. Selection of an image by a user may provide input to LELA™ Archetypal motivators that may influence a user. On this display may also be found item 706, the exemplary indicator of how well a user is being serviced by a provider of an interactive interface.

Referring now to FIG. 7C, in some preferred embodiments, at 707 a user interface that receives input indicating archetypal motivators of a Purchaser or other user may include questions that have two questions on a scale, wherein the Purchaser provides a scaled answer along a continuum formed between the two answers. For example, a Purchase may be queried as to what nurtures the Purchaser. Two answers, such as 1) “reading in bed” and 2) “skydiving over Lake Tahoe”. A scale between the two phrases may have a number of positions with some positions closer to the first answer and some positions closer to the second answer and a position equally distant from the first answer and the second answer. A position chosen provides a weighted indication of an answer closest to how a Purchaser feels. As illustrated, multiple questions and weighted answers along respective scales may be provided.

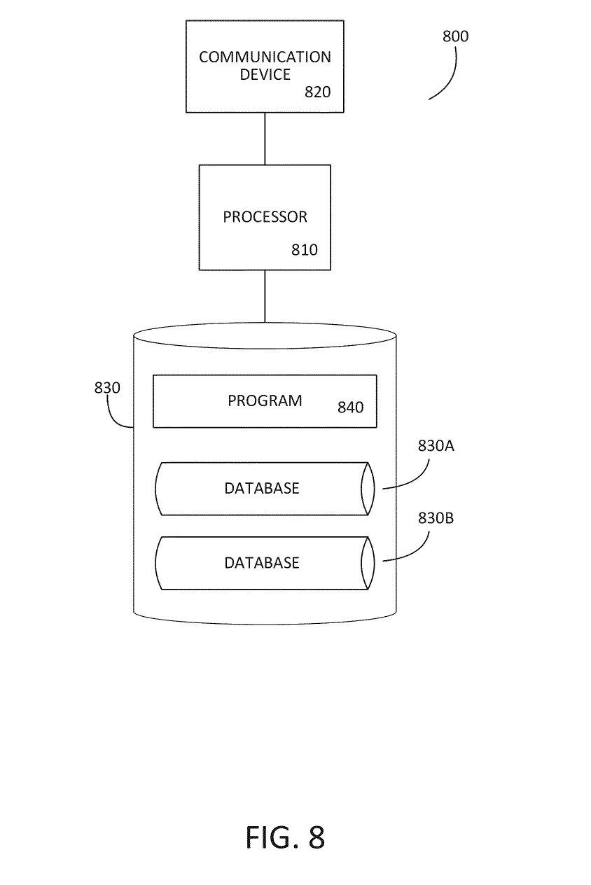

Referring now to FIG. 8, an illustration is provided with a controller 800 that may be embodied in one or more of communications accessible devices and utilized to implement some embodiments of the present invention. Communications accessible devices may include, by way of example, a hand held device such as a cellular phone, a pad device, a personal computer, a server, a personal digital assistant, an electronic reader device or other programmable device.

The controller 800 comprises a processor unit 810, which may include one or more processors, coupled to a communication device 820 configured to communicate via a communication network, such as the Internet, or another cellular based network such as a 3G or 4G network (not shown in FIG. 8). The communication device 820 may be used to communicate with a digital communications network, such as, for example, the Internet available via the Internet Protocol, or a cellular network such as 3G or 4G.

The processor 810 is also in communication with a storage device 830. The storage device 830 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 830 can store a program 840 for controlling the processor 810. The processor 810 performs instructions of the program 840, and thereby operates in accordance with the present invention. The processor 810 may also cause the communication device 820 to transmit information, including, in some instances, control commands to operate apparatus to implement the processes described above. The storage device 830 can additionally store related data in a database 830A and database 830B, as needed.

Methods

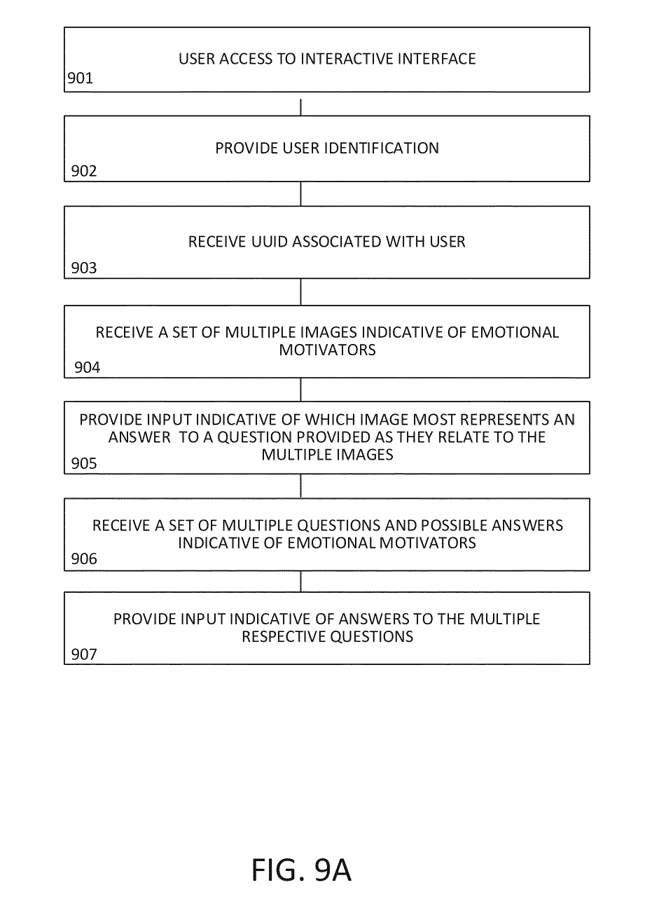

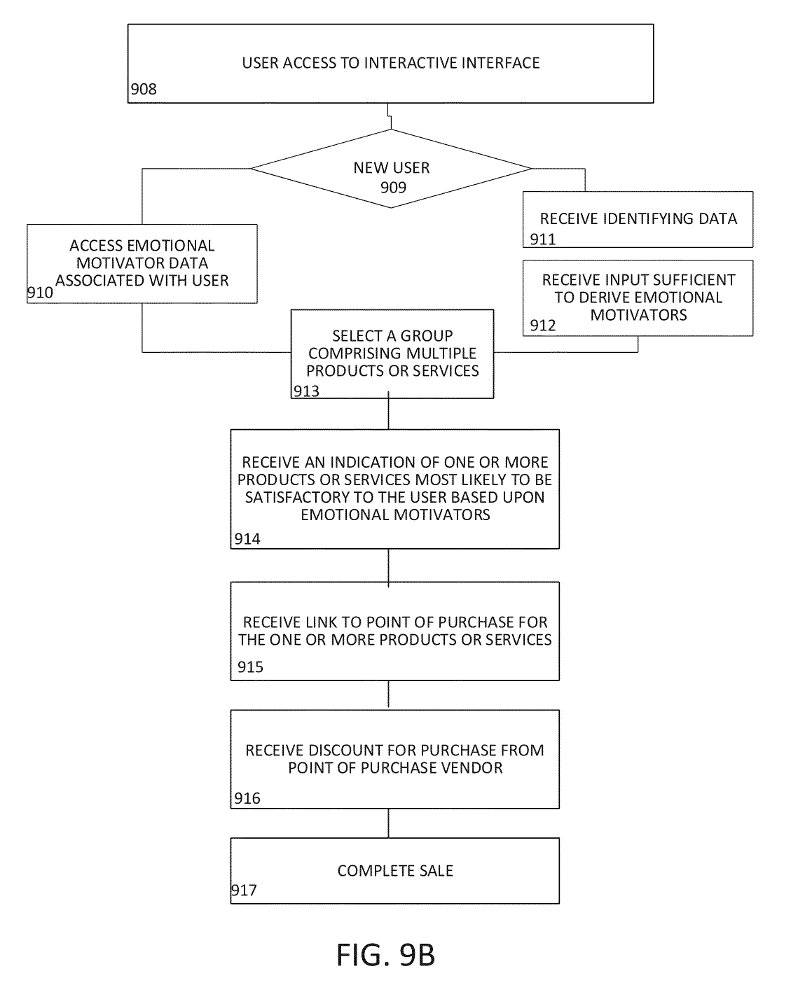

Referring now to FIG. 9A, a flow chart with method steps that may be incorporated into some embodiments of the present invention. The method steps are presented as exemplary and are not required to be executed in a particular order.

At 901, a user, such as a Purchase who is contemplating a purchase for either themselves or for a beneficiary, may access an interactive interface, some preferred embodiments may include access via the Internet or via a mobile phone network, such as, for example, a 3G or 4G network or other cellular or Wi-Fi network.

At 902, the user may provide user identification and at 903 the user may receive a unique identifier, such as, for example in some embodiments, a UUID (universally unique identifier).

At 904, the user may receive a set of multiple images, wherein each respective image is indicative of one or more archetypal motivators. At 905, the user may provide input indicative of which image or images represent an answer to a question provided to the user related to the multiple images.

At 906, the user may also receive one or more questions relating to archetypal motivators. Questions may be presented, for example via written text or via audio. At 907, the user may provide input indicative of an answer to the multiple respective questions. Answers to the multiple questions will be used to associate archetypal motivators with the user.

Referring now to FIG. 9B, additional method steps that may be used to implement some embodiments of the present invention. At 908, a user may access an interactive interface, some preferred embodiments may include access via the Internet or via a mobile phone network, such as, for example, a 3G or 4G network or other cellular or Wi-Fi______33 network.

At 909, the user may indicate whether the user is a new user or already has a profile including emotional motivator data associated with the user. If the user already provided data indicative of the user's archetypal motivators, at 910 the system will access the emotional motivator data associated with the user.

If the user is a new user, or for some other reason does not have data associated with the user, at 911, the system may receive user identifying data and at 912 receive input sufficient to associate or otherwise derive emotional motivator motivators with the user.

At 913, the user may select a group including multiple products or services and at 914 the user may receive an indication of one or more Products or Services most likely to be satisfactory to the user based upon the archetypal motivators associated with the user.

At 915, the user will receive a link to a point of purchase for the one or more Products and/or Services indicated to be satisfactory to the user. In some embodiments, the point of purchase may be a virtual storefront, or other electronic marketplace or webpage, wherein the Purchaser may complete a purchase of a Product via a linked Internet site. In other embodiments, the point of purchase may include a brick and mortar store. A brick and mortar store may include one or more stores determined to be geographically accessible to the user, such as a brick and mortar store in close proximity to the user, such that the user may reasonably travel to the store and make a purchase. A reasonable travel may be based upon a time and cost of travel in relation to a pecuniary value associated with a related Product purchase.

At 916, in order to entice user to become a Purchaser, the user may receive a discount for Purchase from a point of purchase vendor. The discount may be embodied in the form of a coupon, a rebate, a code, a specific link, or other artifact for conveying discount information. In some preferred embodiments, the discount includes a reference to a provider of a service that processes the emotional motivator data. At 917, the user and/or the vendor may complete the sale.

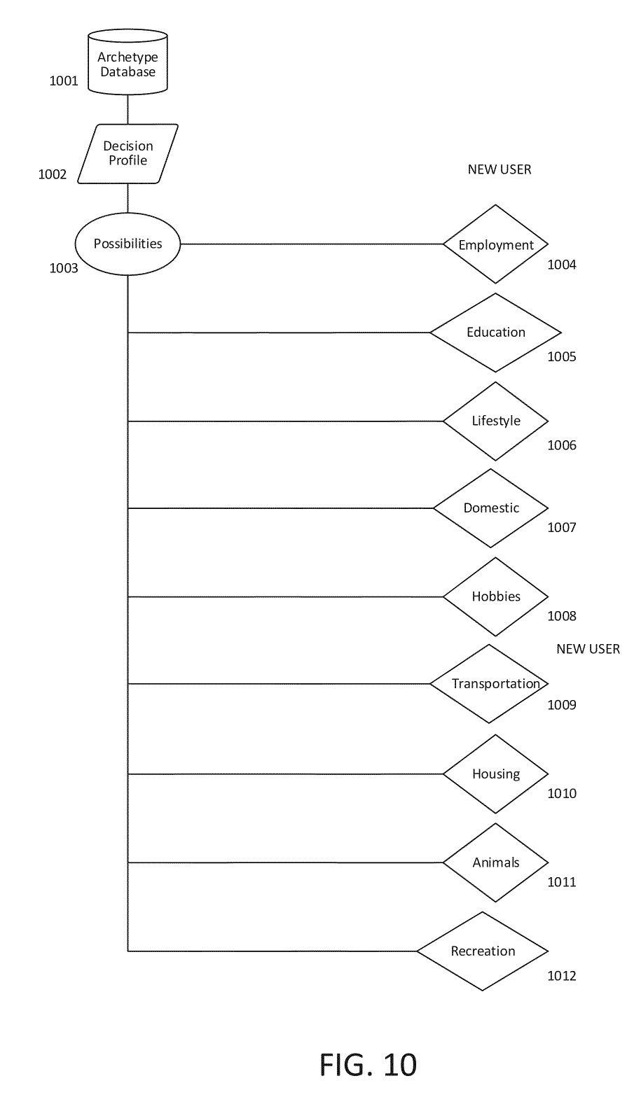

Now referring to FIG. 10, a block diagram that describes the relationship between Archetypes and as an example, a few areas in life in which Archetypes may have an influence on how people make decisions, how they act or react in different facets of life. For example, there are twelve Archetypes that are considered part of the general consciousness of human beings: Advocate, Athlete, Caregiver, Creative, Explorer, Intellectual, Performer, Rebel, Royal, Spiritual, Tastemaker, and Visionary 1001. In addition to the twelve general Archetypes, there are Archetypes that are basic to human nature, for example, Child and Victim, and Archetypes based on psychological theories which may include approximately seventy different types or forms of Archetypes that people may possess that may be more specific or narrower in scope or broader in scope than the twelve general Archetypes.

At 1002, a Decision Profile is based on the Archetypes a person may possess. This Decision Profile may be based on one or more different Archetypes. These Archetypes may include the twelve general Archetypes in addition to other types or forms of Archetypes a person may possess. A person may be a Purchaser or Giftee with the Decision Profile. The person may make the decisions or actions or the person may be the recipient of the decisions or actions.

At 1003, many Possibilities for decisions, actions, or paths to take in life are given. The Possibilities are connected to different life events a person may experience. A person who possesses a certain set of Archetypes that has a specific Decision Profile 1002, may make many decisions based on the Possibilities 1003 presented to them. Examples of Possibilities may include, but is not limited to: Employment 1004, Education 1005, Lifestyle 1006, Domestic 1007, Hobbies 1008, Transportation 1009, Housing 1010, Animals 1011, and Recreation 1012.

In 1004, a person may make decisions on what type of Employment they would like to have. The Employment may be full-time or part-time work, and may be in a particular industry which may include, but is not limited to, health care, finance, or technology. A person may make decisions for the Domestic 1007 area of their life, which may include, but is not limited to, deciding to be single or to join another person in marriage, or if a person plans to have children. Additionally, a person may make decisions based on their mode of Transportation 1009 which may include their preferred method of long distance travel and what vehicle is used for daily transportation. Furthermore, a person has Possibilities as to what Animals 1011 a person may possess during their life. For example the decisions may be based on if the Animal is for companionship or to earn income. The Classification of the Animal and the Species in particular are included, but not limited to, in the Possibilities 1003 a person has based on their Decision Profile 1002.

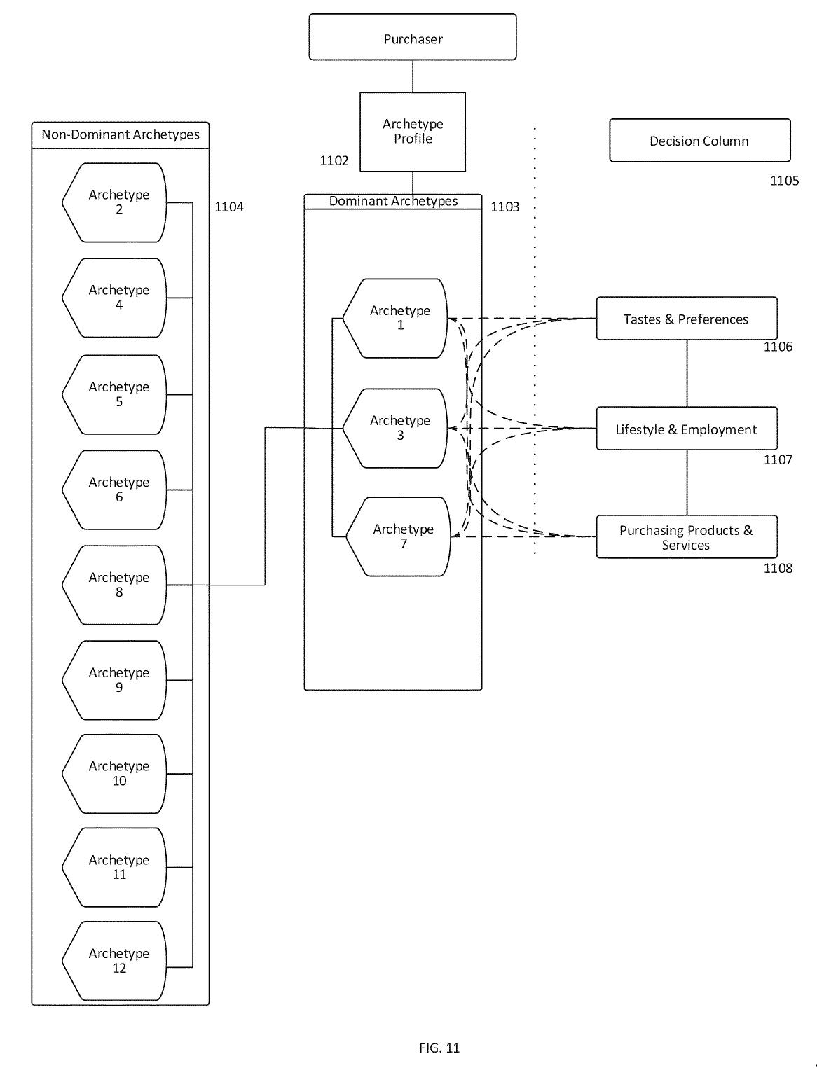

Referring now to FIG. 11, a block diagram illustrates how Archetypes may be more dominant than others at any point in a Purchaser's life. Archetypes may fluctuate in dominance throughout a lifetime or stay steady. A Purchaser may have one Archetype dominant or more than one Archetype dominant while the rest are non-dominant and may have little influence on the decisions or actions a Purchaser may make. Archetypes may be on a proportion scale such that an Archetype may dominate in that Purchaser based on a higher portion of the scale or percentage being assigned to a particular Archetype. However, an Archetype may not be dominant in a Purchaser's life and may have a lesser portion or percentage on a proportion scale.

At 1103, three Dominant Archetypes are displayed for this Purchaser. More than three or less than three Dominant Archetypes may be possessed by the Purchaser's Archetype Profile 1102 at any time in their life. For example, this Purchaser could be a Rebel, a Performer, and an Explorer. Additionally, this Purchaser may not be evenly distributed with the Archetypes and may have varying degrees assigned to the dominant Archetypes, or the dominant Archetypes may be evenly distributed with some remaining distribution assigned to the non-dominant Archetypes. An example of a percentage distribution on a proportion scale may be Archetype 1 is 31%, Archetype 3 is 28%, Archetype 7 is 29%, and the remaining Archetypes in the Non-Dominant Archetype column 1104 are at 12% to complete the proportion scale. Another example is the even distribution with Archetypes 1, 3, and 7 1103 each at 30%, such that the Dominant Archetypes have 90% on the proportion scale and the remaining 10% is evenly distributed to the Non-Dominant Archetypes 1104.

At 1104, the non-dominant Archetypes may have a minimal role in the Purchaser's decisions. At any point in the life of the Purchaser, Archetypes may switch places. For example, Rebel may be replaced with Visionary. At a later time in the life of the Purchaser, Visionary may be replaced with Rebel or any other available Archetype.

At 1105, a Decision column is present that correlates to the dominant Archetypes. Depending on the dominant Archetypes, many decisions may be made by a Purchaser. The decisions may come from prior decisions, the decisions may correlate to each other, or they may relate to one or more Archetypes or any other factors that may affect Emotional Reasoning or Archetypal motivators at that time. The Decisions may be based upon the dominant Archetypes the Purchaser possesses at that time as well as tastes and preferences 1106 in style, color, sizing of the item, or the lifestyle and employment 1107 may affect the decision. For example, a person with a family may decide to purchase a minivan or sport utility vehicle for vehicle transportation; in contrast, a person who travels longer distances for employment would want something gas efficient and comfortable on long drives, like a hybrid vehicle or a luxury sedan. The Purchasing of Products and Services 1108 may be influenced by the Dominant Archetypes 1103 as a whole or by one or two of the Dominant Archetypes. In addition to the Dominant Archetypes, the Purchasing decision may be influenced by other factors that the Dominant Archetypes may influence like Tastes and Preferences 1106, and Lifestyle and Employment 1107 which may also be influenced by one, two, or more Dominant Archetypes.

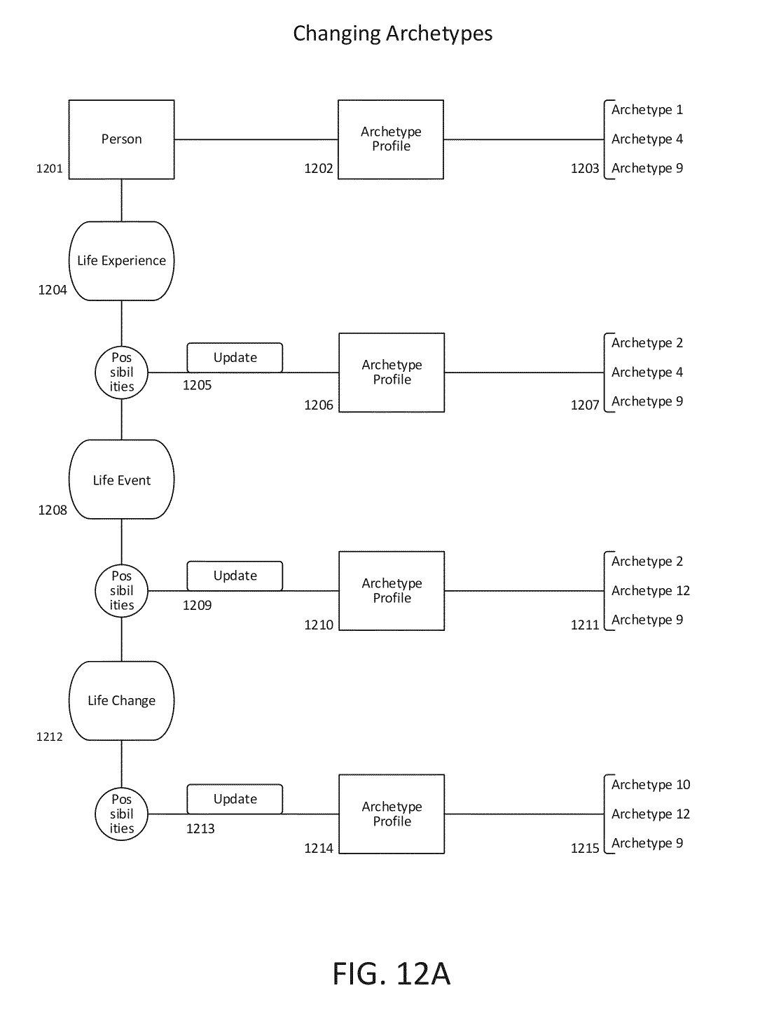

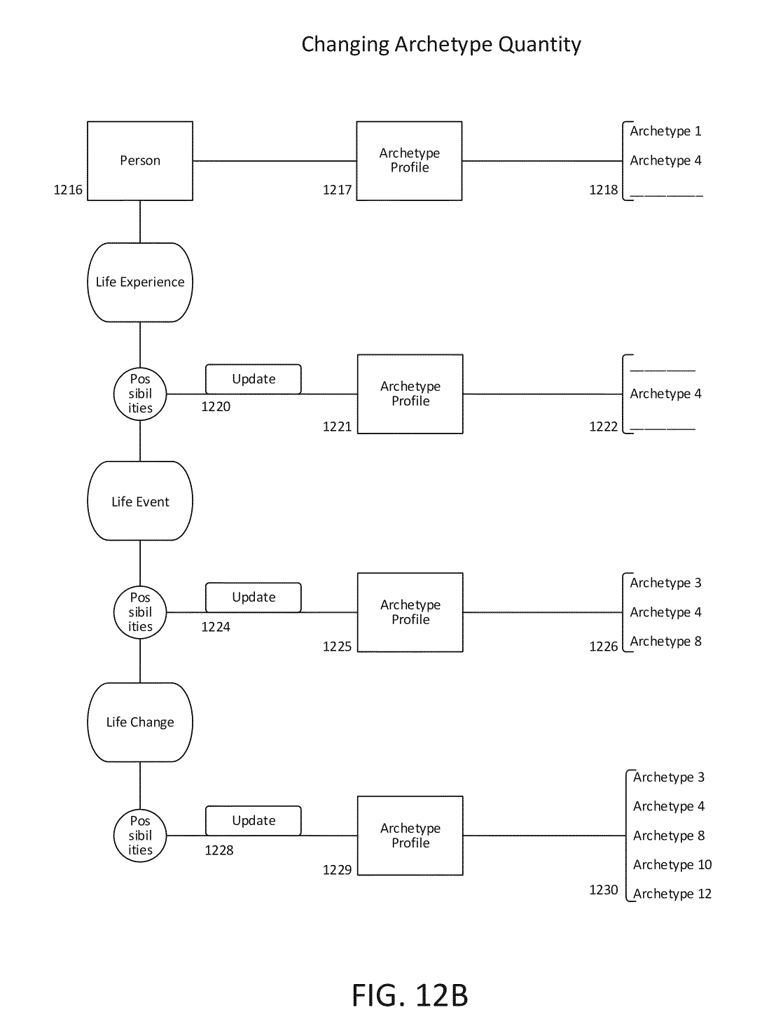

Referring to FIG. 12A, a flow-chart illustrating how a person may possess different Archetypes during their lifetime. Certain events may bring forth a change in Archetypes such that a person 1201 may possess certain Dominant Archetypes and after the event a Dominant Archetype may be exchanged for a Non-Dominant Archetype. For example a person may possess three dominant Archetypes at any time in their life and they may keep all their Archetypes after a life event or they may exchange one Archetype for another. At some point in time, a person 1201 may have an archetype profile 1202 with a collection of archetypes.

At 1204, 1208, and 1212 a person may encounter an Experience, Event, and Change at some time during their life. For example, a traumatic experience from a car accident or near death experience to their self or to a friend or relative may create a change in the person such that Archetype 1 1203 may change from Royal to Archetype 2 1207 which is Caregiver. These Life Experiences, Events, and Changes may be minimal or large in scope and affect to a person.

At 1205, 1209, and 1213 and Update occurs to the person following the Experience 1204, Event 1208, and Change 1212. The Update may cause a change to the Archetype Profile in 1206, 1210, and 1214. The Update in the Archetype Profile may occur quickly or immediately, or the Update could be gradual over time.

At 1203, 1207, 1211, and 1215, a series of three Archetypes are displayed in the flow chart. These Archetypes may stay the same or one, two, or all three may change following an Update to the Archetype Profile. An example in the flow chart is Archetype 9 is a constant during the life of the person, while the other Archetypes may continue to stay a constant Dominant Archetype or a Non-Dominant Archetype may take the place of a previously Dominant Archetype.

Referring to FIG. 12B, a flow-chart illustrating how a person may possess different Archetypes during their lifetime and how a person may possess differing amounts of Dominant Archetypes during their life may be found. An example may be during an employment change for a more demanding position; the person may only possess the Intellectual Archetype because of the demands on the person at that time in their life. Another example may be when a person enters parenthood the Intellectual Archetype may become Non-Dominant and Spiritual and Caregiver become two Dominant Archetypes possessed at that time in their life. The dominance and variation in Archetypes may change during a person's lifetime. A person 1216 may possess one, two, three, or more dominant Archetypes at any time or they may not possess any dominant Archetypes at that time in their life and rely on other factors for Emotional Reasoning and Archetypal motivators.

At 1218, two Dominant Archetypes are present, at 1222 only one Dominant Archetype is present, at 1226 three Dominant Archetypes are present, and lastly at 1230 five Dominant Archetypes are present. The Archetype Profiles at 1221, 1225, and 1229 have changed from the Archetype Profile 1217 and from each other. These Updates 1220, 1224 and 1228 of the Archetype Profile may occur once, or it may occur two or more times in the life of a person, or there may not be a change to a person's Archetype Profile during their life. For example, a person may possess two Dominant Archetypes, a life experience like going to college occurs. Before, during, or after college that person's Archetype Profile may Update and only one Dominant Archetype is possessed, the Intellectual. Later in time for that person a Life Event may occur, for instance, marriage. Before, during, or after the consummation, an Update to the Archetype Profile may occur and now three Dominant Archetypes are possessed: Caregiver, Intellectual, and Explorer. Later in time for that person a Life Change may occur, for instance, an illness affects their health. Their Archetype Profile may update to include five Dominant Archetypes: Caregiver, Intellectual, Explorer, Advocate, and Spiritual. The continual change and Updating of the Archetype Profile may occur at any time in a person's life or may not change at all.

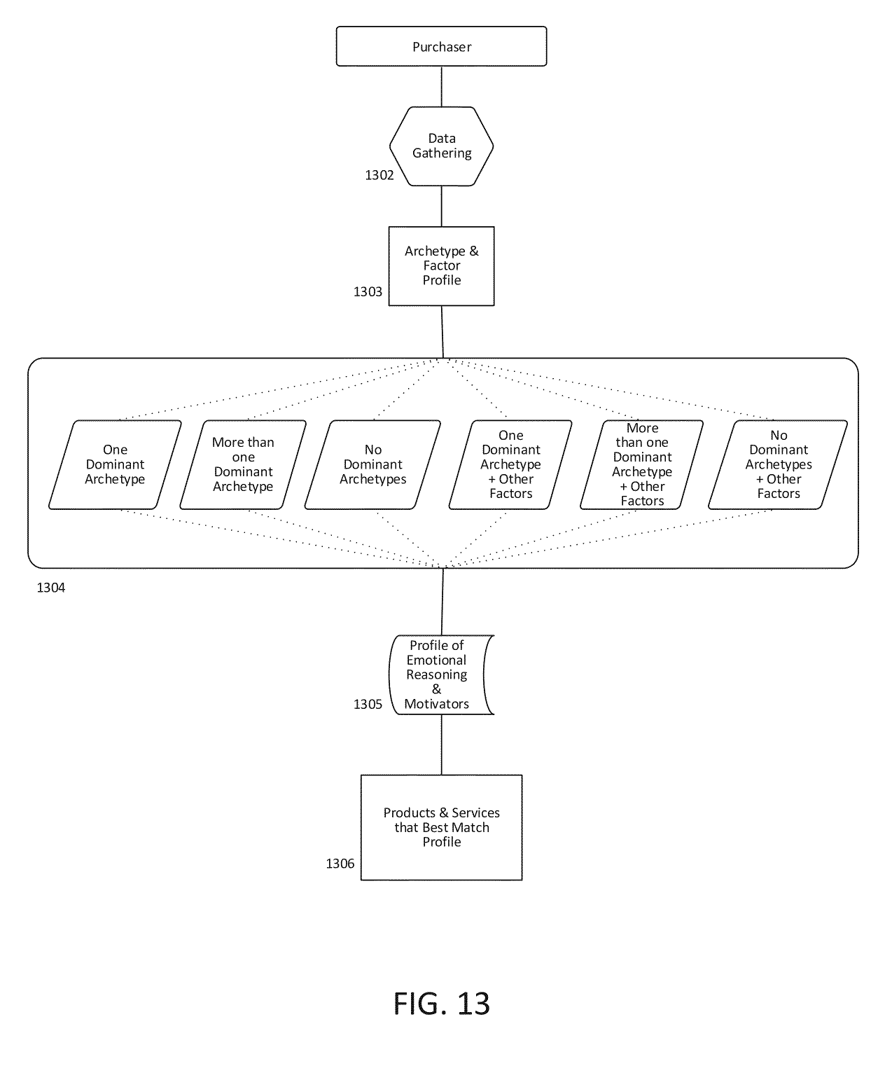

Now referring to FIG. 13, a flow chart illustrates how a Purchaser may have an Emotional Reasoning and Motivator Profile 1305 that consists of Archetypes and Other Factors. A Purchaser may possess different Archetypes in their Profile of Emotional Reasoning and Motivators such as the twelve general Archetypes: Advocate, Athlete, Caregiver, Creative, Explorer, Intellectual, Performer, Rebel, Royal, Spiritual, Tastemaker, and Visionary. Additionally, Other Factors may or may not be in the Emotional Reasoning and Motivator Profile which may include, but is not limited to: budget, making the decision with another person or another Purchaser, whom the decision is for (yourself or another), age, and/or if the decision is based on a progression of events.

At 1302, Data Gathering gleans data about user insights from GUI activity, what type of device is being used by the user (Apple, PC, Mobile), the location of the user, browsing history, purchase history, and a user may be asked to answer a series of questions or through an interface create what is desired. Other alternatives for data gathering which may include, but are not limited to are: drawing, a series of choices, and other alternative interfaces.

At 1303, an Archetype and Factor Profile is created based on the Data Gathering. The Archetypal Determining Data may be constructed of many different combinations of Archetypes and Other Factors 1304. An Archetype and Factor Profile may include, but is not limited to: one Dominant Archetype, more than one Dominant Archetype, no Dominant Archetypes, or it may be a combination of Other Factors with One Dominant Archetype, more than one Dominant Archetype with Other Factors, or no Dominant Archetypes with Other Factors. An example of an Archetype and Factor Profile may include the Tastemaker as a Dominant Archetype with Other Factors of budget, friend or familial influence or recommendation, color and size preference, and is there a need or a want. Or the Archetype and Factor Profile may only include Dominant Archetypes, for instance: Advocate, Performer, Royal, and Visionary.

At 1305, a Profile of Emotional Reasoning and Motivators is established as described in FIG. 6. Data Gathering 1302 and the Archetype and Factor Profile 1303, 1304 may be included in this Profile. Dominant Archetypes may be included in the Emotional Reasoning and Motivators when making a decision or Other Factors may be more influential or have a higher or lower proportion based on a proportion scale.

At 1306, Products and Services that Best Match Profile may be available to the Purchaser. The Products and Services may be from any consumer goods market foreign and domestic. Additionally, the Products and Services may include, but are not limited to Products and Services: available for purchase, as a recommendation for purchase, or as inspiration for self-creation.

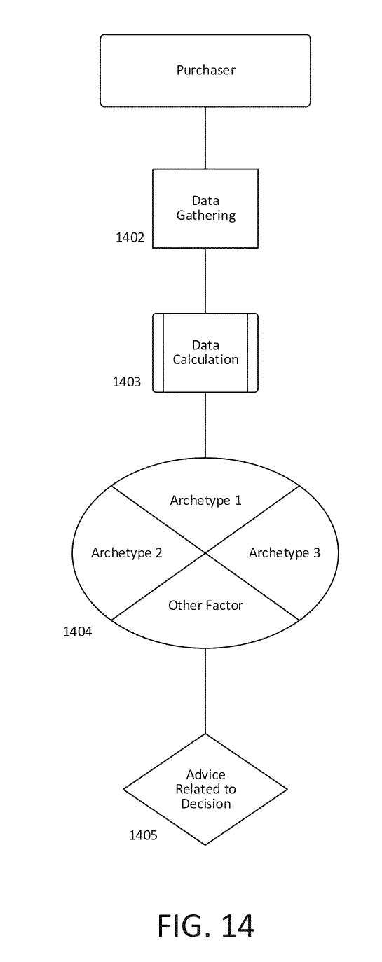

Referring now to FIG. 14, a flow chart for how a Purchaser may receive advice using the Archetype data. Advice may be based upon Archetypes and Other Factors as described in FIG. 13. The Data Gathering 1402 as described in FIG. 13, proceeds to the Data Calculation 1403. The Data Calculation may occur during the immediate moments or gradually over time. Additionally, the Data Calculation may encompass all past advice given or may include, but is not limited to recalculation due to current wants and needs, new product and service offerings, changes in budget, replacement of previous products and services, current style and preference trends, and economic factors. Data Calculation may also include a Product Expert which evaluates attributes and features of products as described earlier.

At 1404, the Purchaser possesses Archetypes and is also influenced by Other Factors. For example this Purchaser may have three Dominant Archetypes: Performer, Explorer, and Caregiver; or any of the Archetypes described in FIG. 10. This Purchaser may also have another Factor they possess; for example, the Other Factor may include but is not limited to: gender, price, buying season, income, employment, and or family and friends influence; as well as Factors as described in FIG. 13. The Dominant Archetypes may have a large percentage and the Other Factor may have a small percentage on a proportion scale. Or, all of the Archetype and Factors present may have equal weight on a proportion scale.

At 1405, Advice Related to Decision is then calculated for the Purchaser. The advice given may be for any decision the Purchaser is looking to make, which may or may not include the purchase of a product or service, a choice based on events in life, or an employment or business decision. The Advice may be a recommendation for a particular purpose or it may be for a general purpose, or any variance of scope or amount of specificity required as referred to in FIG. 5. Additionally, the Advice Related to Decision may change in the immediate moment based on immediate needs, or the Advice Related to Decision may change gradually, the changes may be due to the Purchaser's Archetype Profile changing, as referred to in FIGS. 12A and 12B.

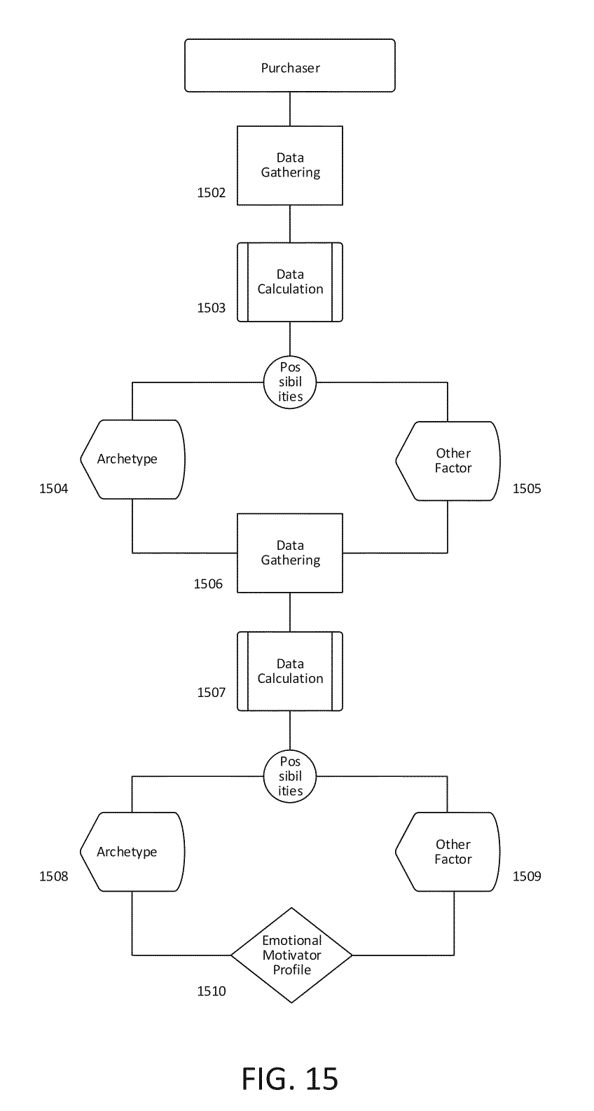

Referring now to FIG. 15, a flow chart illustrates the process in which a Purchaser establishes Archetypes and Other Factors for an Emotional Motivator Profile. The process this flow chart illustrates may be very simple and may have as few as one set of Data Gathering and Data Calculations or the process may be repeated many times over. In addition, the process may be a continual progression through the flow chart with continuous updates. For multiple Data Gathering and Data Calculations, the calculating of the Archetypes and Other Factors may be based on previous Data Calculations already in the Emotional Motivator Profile.

At 1502 and 1503, methods of Data Gathering and Data Calculation are used as referenced in FIGS. 13 and 14. The Data Calculation flows to the establishment of an Archetype 1504 and an Other Factor 1505. The Archetype and Other Factor then flow into another set of Data Gathering 1506 and Data Calculation 1507. This next set of Data Gathering 1506 may be determined from the preceding Archetype and Other Factor. For example, a progressive line of questions may be asked where the subsequent questions may be created on the answers to the previous question. Alternatively, a standard line of questions may be asked where the previous answer does not affect the current question. Or, there may be a combination of the progressive questions and standard questions. For example, a standard set of questions may be asked for males or females, parents or non-parents, and other segmentations of customers. Once the market segmentation is calculated by a progressive line of questions, then the standard questions may start. On the other hand, a set of standard questions may be first along with other forms of Data Gathering to determine what segmentation of the market is the Purchaser. Then the questions may become progressive to narrow the scope of the Purchasers needs and wants, tastes and preferences, and other determining elements to base a decision on.

At 1504 and 1508, an Archetype may be determined to be possessed by the Purchaser through the preceding Data Gathering and Data Calculations. The Archetypes possessed by the Purchaser may be one or more dominant Archetypes as referred to in FIG. 12A and 12B. For example, the Purchaser may be a Tastemaker and Performer as their Dominant Archetypes in this flow chart. However, no Dominant Archetypes may be established during the process of Data Gathering and Data Calculation.

At 1505 and 1509, Other Factors may be determined to be possessed by the Purchaser through the preceding Data Gathering and Data Calculations. The Other Factors possessed by the Purchaser may be one or more different Factors determined to be relevant to the Purchaser as referred to in FIGS. 13 and 14. For example, the Purchaser may have a rustic decorating taste and preference for shades of beige with a $2,000 decorating budget. However, no Other Factors may be relevant to the Purchaser during the Data Gathering and Data Calculation.

At 1510, the Data Gathering and Data Calculation have established Archetypes and Other Factors that will be relevant in the Emotional Motivator Profile for the Purchaser. The Emotional Motivator Profile may consist of none, one, or more Archetypes and may consist of none, one, or more Other Factors that are important to Purchaser.

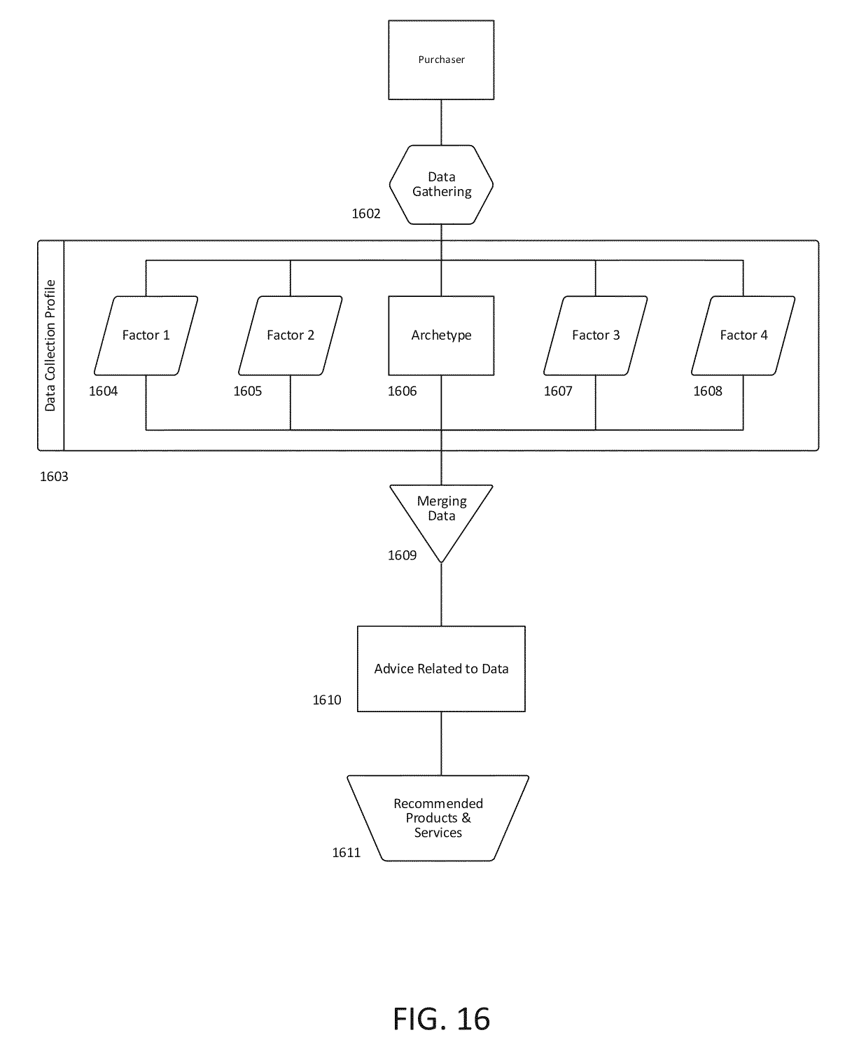

Referring now to FIG. 16, a block diagram illustrates the process of establishing Motivators and Emotional Reasoning for purchasing of products and services which may be included in the Apparatus of the present invention. When establishing Emotional Reasoning any series of events may entail the behaviors a Purchaser may have, the processes a Purchaser may utilize, and preferences for certain products and services, then Advice Related to Data calculated in the Data Gathering may be created. Methods of establishing Motivators and Emotional Reasoning are through, Archetypes and Other Factors. Many Archetypes may be possessed by a person where some may be dominant and others not dominant as referenced in FIG. 11. Other factors may influence a person and what Archetypes they possess, including but not limited to: age, gender, income, and geography as referenced in FIGS. 13 and 14.

At 1602, Data Gathering is conducted as described in FIG. 14, which flows into the Data Collection Profile 1603. The Data Collection Profile holds all the information, Factors, and Archetype data that are determined through the Data Gathering. Inside the Data Collection Profile, there are Factors 1604, 1605, 1607, and 1608, and Archetypes 1606. For example, Factor 1 may be the Purchaser is an Apple computer user, Factor 2 may be the Purchaser is using his laptop while traveling, Factor 3 may be the Purchaser has a contemporary style; Factor 4 may be the Purchaser is a traveling nurse, and the Dominant Archetype is Athlete. In the Data Collection Profile, there may be one or more Factors or no Factors, and there may be one or more Dominant Archetypes or no Dominant Archetypes. The Data Gathering may be a continuous process over time or it may happen in a short amount of time.

At 1609, the Data is merged into a usable format to then determine what the Purchaser is shopping for or what the Purchaser is making a decision on. The Merging Data can comprise of all Data on the Purchaser, all Data on a website or database, and any other references from manual inputs and other resources.

At 1610, Advice Related to Data is now available for the Purchaser. After taking in to account for the Archetypes and Factors and any other relevant Data from the Purchaser Emotional Motivator and Reasoning Profiles, the Purchaser can be given Advice. If the Purchaser is determining what products are services are recommended to them, the Advice Related to Data will flow to the Recommended Products and Services 1611. The Purchaser will then have the opportunity to choose what products and services are recommended to them based on all the Advice Related to Data. For example, using the Purchaser described above, the traveling nurse who is an Athlete Dominant Archetype, is currently traveling, using his Apple laptop, and has contemporary style is wanting a recommendation on hotels at his next assignment. He can now be matched up with hotels that have a contemporary style, have a gym or access to a gym, have amenities for customers who will reside there for longer periods of time, and is in the city or preferred location of the next assignment. Many different recommendations may be made for many different products and services. For example, recommendations on dining out, what vehicle to buy, what electronics to buy, where to go on vacation, what hobby best fits a user, or other decision possibilities.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware may be implemented. Accordingly, other embodiments are within the scope of the following claims.

What is claimed is:

1. Automated apparatus for providing advice to a Purchaser to make the Purchaser more satisfied with a purchasing decision based upon archetypes, the apparatus comprising:
a processor in logical communication with a digital storage device, the digital storage device storing executable software code, executable upon command to cause the apparatus to:
transmit via a communications network, a first interactive user interface to a network access device, said first interactive user interface comprising a device for the Purchaser to select one of multiple images indicative of archetype motivators;
receive a first Purchaser input indicating an image selected from the multiple images indicative of archetype motivators;
transmit via the communications network, a second interactive user interface to the network access device, said second interactive user interface comprising multiple questions indicative of archetype motivators;
receive via the communications network, a second Purchaser input indicating respective answers provided by the Purchaser to each of the multiple questions indicative of archetype motivators;
generate a user archetype profile for the Purchaser based upon the selected image and the respective answers provided by the Purchaser to each of the multiple questions indicative of archetype motivators, wherein the archetype profile comprises at least one dominant archetype and at least one non-dominant archetype;
associate dominant and non-dominant archetypes with a Product based upon attributes of the Product;
receive from the Purchaser, via the communications network, a selection of a type of product the Purchaser is interested in purchasing;
match the at least one dominant archetype and at least one non-dominant archetype associated with the Purchaser with the at least one dominant archetype and at least one non-dominant archetype associated with the Product; and
transmit to the Purchaser a third interactive user interface comprising a description of the Product.

2. The apparatus of claim 1 wherein the processor is additionally operative to transmit to the Purchaser a discount artifact entitling the Purchaser to a discounted price for the Product described in the third interactive user interface.

3. The apparatus of claim 2 wherein the processor is additionally operative to transmit to the Purchaser a link to a virtual point of purchase for the Product described in the third interactive user interface.

4. The apparatus of claim 2 wherein the processor is additionally operative to:
determine a physical point of purchase geographically local to the Purchaser;
determine that the physical point of purchase stocks the Product which is described in the third interactive user interface; and
transmit a map comprising the physical point of purchase geographically local to the Purchaser.

5. The apparatus of claim 1 wherein the processor is additionally operative to transmit a Purchaser interactive display comprising a description of archetypal motivators associated with the Purchaser and comprising the at least one dominant archetype and at least one non-dominant archetype associated with the Purchaser.

6. The apparatus of claim 1 wherein the processor is additionally operative to display a history of Purchase transactions completed by the Purchaser.

7. The apparatus of claim 1 wherein the processor is additionally operative to display a history of inputs comprising indications of archetypal motivators associated with the Purchaser.

8. The apparatus of claim 1 wherein the processor is additionally operative to transmit an indication of how well a software engine designed to quantify archetypal motivators is aware of Purchaser preferences based upon archetypal motivators.

9. The apparatus of claim 1 wherein the processor is additionally operative to transmit an indication of which archetypal motivators are associated with the Purchaser.

10. The apparatus of claim 1 wherein the processor is additionally operative to transmit to the Purchaser an indication of archetypal motivators associated with the Product chosen by the Purchaser.

11. A computerized method for providing advice related to a Purchase decision, the method comprising:
transmitting a Purchaser interface for making selections which indicate archetype motivators of a Purchaser;
receiving one or more indications of archetype motivators comprising a Purchaser dominant archetype and a Purchaser non-dominant archetype associated with the Purchaser;
associating a Product dominant archetype and a Product non-dominant archetype with a Product;
transmitting a Purchaser interface for receiving a selection of a type of Product the Purchaser is interested in;
determining that the Product will be satisfactory to the Purchaser based upon the dominant archetype and a non-dominant archetype associated with the Purchaser; and
transmitting a display descriptive of the Product determined to be satisfactory to the Purchaser based upon archetype motivators associated with the Purchaser.

12. The method of claim 11 wherein the method additionally comprises the step of transmitting a discount artifact entitling the Purchaser to a discounted price for the one or more Products determined to be satisfactory to the Purchaser.

13. The method of claim 12 wherein the method additionally comprises the step of transmitting a link to a virtual point of purchase for the one or more of the Products determined to be satisfactory to the Purchaser based upon archetype motivators associated with the Purchaser.

14. The method of claim 11 wherein the method additionally comprises the step of receiving a link to a geographically local point of purchase for one or more of the Products determined to be satisfactory to the Purchaser based upon archetype motivators associated with the Purchaser.

15. The method of claim 11 wherein the method additionally comprises the step of transmitting a Purchaser interactive display comprising a description of archetype motivators associated with the Purchaser.

16. The method of claim 11 wherein the method additionally comprises the step of transmitting a history of Purchase transactions completed by the Purchaser.

17. The method of claim 11 wherein the method additionally comprises the step of transmitting a history of inputs comprising indications of archetype motivators associated with the Purchaser.

18. The method of claim 11 wherein the method additionally comprises the step of transmitting an indication of how well a software engine designed to quantify archetype motivators is aware of Purchaser preferences based upon archetype motivators.

19. The method of claim 11 wherein the method additionally comprises the step of transmitting to the Purchaser an interface comprising an indication of the dominant archetype and the non-dominant archetype associated with the Purchaser.

20. The method of claim 11 wherein the method additionally comprises the step of transmitting to the Purchaser an interface comprising a description of the dominant archetype and the non-dominant archetype associated with the Product determined to be satisfactory to the Purchaser based upon archetype motivators associated with the Purchaser.
